(19) United States
(12) Patent Application Publication
(10) Pub. No.: US 2006/0045055 A1
(43) Pub. Date: Mar. 2, 2006

(54) Method and apparatus for deploying an ad-hoc network

(76) Inventors: Padmaja Ramadas, Davie, FL (US); Yan Huang, Weston, FL (US); Matthew R. Perkins, Sunrise, FL (US)

Correspondence Address: MOTOROLA, INC., 1303 EAST ALGONQUIN ROAD, IL01/3RD, SCHAUMBURG, IL, 60196, US

(21) Appl. No.: 10/929,510

(22) Filed: Aug. 30, 2004

(51) Int. Cl. H04Q 7/24

(52) U.S. Cl. 370/338

(57) ABSTRACT

A method and apparatus for real-time ad-hoc network deployment is provided herein. During deployment, nodes that make up the network are periodically dropped in a serial fashion. During deployment, a node will immediately determine if it will become a network coordinator by determining if a piconet coordinator beacon is heard. If, during deployment, a beacon isn't heard, the node will become a piconet coordinator and will assume those responsibilities immediately.

### STATEMENT REGARDING FEDERALLY SPONSORED RESEARCH OR DEVELOPMENT

This invention was made with United States Government support under Agreement No. 70NANB2H3001 awarded by the National Institute of Standards and Technology (NIST). The United States Government has certain rights in the invention.

### FIELD OF THE INVENTION

The present invention relates generally to ad-hoc networks, and in particular, to a method and apparatus for deploying an ad-hoc network.

### BACKGROUND OF THE INVENTION

Wireless ad-hoc communication systems allow a number of data devices (nodes) to communicate with each other. Such communications are normally confined to about 10 meters in all directions, whether the node is stationary or in motion. Because of the short-range nature of any communication, typical ad-hoc networks comprise a number of piconets that overlap to create a logical communication backbone underpinned by the physical radio connections that exist between devices in the various piconets. All piconets usually have a single piconet controller (PNC), or coordinator. The coordinator is responsible for timing synchronization of the devices within its piconet, for assigning unique network addresses, for routing messages, for broadcasting device discovery and service discovery information, and possibly for power control.

Recently, it has been proposed to utilize such ad-hoc networks to aide in emergency services. For example, ad-hoc networking can be employed within a fireground to aide communications between emergency service providers (e.g., firemen, policemen, . . . , etc). However, existing deployment algorithms make it extremely difficult to rapidly deploy such a network and still guarantee that the network will self-assemble in a “fully connected” fashion to provide ubiquitous coverage. For example, existing deployment algorithms utilize exploration and map building with aid of robots, stored maps, and stored sensory data; and thus cannot be built entirely “real time”. Additional algorithms require physical placement of the sensor nodes in a precise (“optimal”) location for the algorithms to work (which means they require some sort of fixed infra structure, defying the purpose of ad-hoc network).

For mission critical situations, emergency service providers cannot afford the time to precisely distribute nodes to achieve connectivity, nor can they depend on stored maps to deploy nodes. Hence, a need exists for a method and apparatus for deploying an ad-hoc network in real time that assures connectivity at all times.

### BRIEF DESCRIPTION OF THE DRAWINGS

FIG. 1 is a block diagram of an ad-hoc network.

FIG. 2 is a flow chart showing the steps necessary for deploying the ad-hoc network of FIG. 1.

FIG. 3 illustrates node deployment.

FIG. 4 shows a node deployment for a random walk and random drop rate.

FIG. 5 is a high-level block diagram of a node.

FIG. 6 is a flow chart showing operation of the node of FIG. 5.

### DETAILED DESCRIPTION OF THE DRAWINGS

To address the above-mentioned need a method and apparatus for real-time ad-hoc network deployment is provided herein. During deployment, nodes that make up the network are periodically dropped in a serial fashion. During deployment, a node will immediately determine if it will become a network coordinator by determining if a piconet coordinator beacon is heard. If, during deployment, a beacon isn't heard, the node will become a piconet coordinator and will assume those responsibilities immediately.

Because network coordinators are elected immediately upon deployment, and without contention, every other node that is deployed after a coordinator (and in its transmission range) immediately knows its role in the network (it will become a regular device 102). This feature eliminates all communications overhead, allowing fast deployment without initialization contention. Additionally, because piconets overlap, and many devices are deployed within the overlap region, the network is fully connected.

The present invention encompasses a method for deploying an ad-hoc network. The method comprises the step of serially dropping a plurality of ad-hoc nodes throughout a geographic area, where the plurality of ad-hoc nodes automatically become a piconet coordinator based on a threshold.

The present invention additionally encompasses a method comprising the steps of determining that a node has been deployed, determining if a beacon has been heard, and becoming a piconet coordinator if the beacon has not been heard otherwise becoming a standard node within an ad-hoc communication system.

The present invention additionally encompasses an apparatus comprising a sensor determining that a node has been deployed, and logic circuitry determining if a beacon has been heard and instructing the node to become a piconet coordinator if the beacon has not been heard, otherwise instructing the node to become a regular node within an ad-hoc communication system.

The present invention additionally encompasses an apparatus comprising a sensor determining that a node has been dropped and logic circuitry determining whether or not to become a piconet coordinator based on if the node has been dropped, wherein the logic circuitry determines whether or not to become a piconet coordinator based on a statistic.

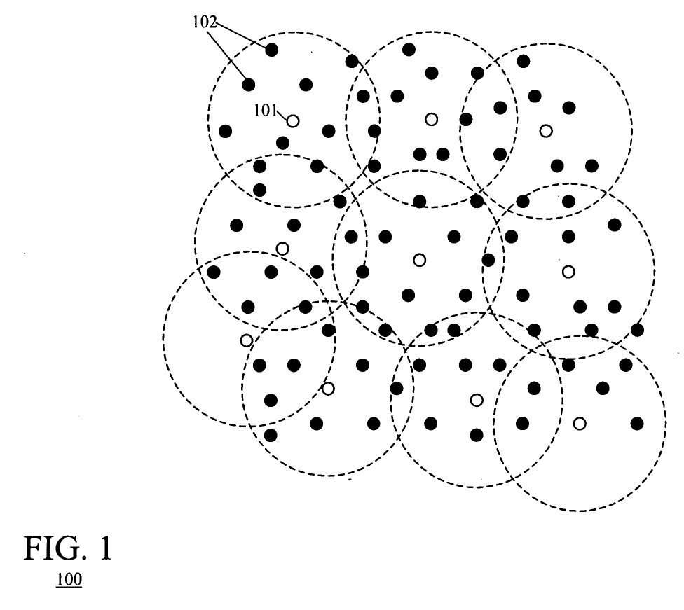

Turning now to the drawings, wherein like numerals designate like components, FIG. 1 is a block diagram of communication system 100. In the preferred embodiment of the present invention communication system 100 comprises an ad-hoc communication system such as a neuRFon™ communication system, available from Motorola, Inc. As shown, communication system 100 comprises a plurality of nodes 101 and 102. During the network deployment, an infrastructure is formed with a subset of nodes 101 (10 are shown in FIG. 1) that receive communication requests and announce communication schedules to their neighboring nodes. The description of the formation procedure is described in detail below. Nodes 101 are typically identified as Coordination Devices or Piconet Coordinators (PNCs), which may facilitate low duty cycle coordinated communications in neuRFon™ networks. Any node 102 in such a network will be in the range of one or multiple coordinators 101.

During typical transmission, a device (or node) 102 will schedule a time period to transmit, and to receive. Additionally, each coordinator will periodically broadcast a beacon, identifying it as a coordinator and providing system information to nodes in communication with the coordinator's range. Thus, as known in the art each coordinator 101 has a time window (reservation window) to receive its neighbors' 102 communication requests (for both unicast and broadcast) in each period. Each coordinator 101 additionally has a time window (beacon window) to broadcast the beacon comprising necessary information for the piconet in each period, to its neighbors 102. The necessary information comprises information such as, but not limited to information necessary for assigning unique network addresses to nodes, for routing messages, for broadcasting device discovery and service discovery information, and information necessary for power control.

The established network structure allows all neighboring nodes 102 to synchronize with its coordinator's beacon window. Thus, all nodes 101 and 102 should wake up in a beacon window to receive piconet information.

As discussed above, it has been proposed to utilize such an ad-hoc network to aide in emergency services. However, existing deployment algorithms make it extremely difficult to rapidly deploy such a network and still guarantee that the network will self-assemble in a “fully connected” fashion to provide ubiquitous coverage. In order to address this issue, in the preferred embodiment of the present invention nodes are deployed in a serial fashion (i.e., one at a time). During deployment, a node will immediately determine if it will become a PNC by determining if a PNC beacon is heard or not. If, during deployment, a PNC beacon isn't heard, the node will become a PNC 101 and will assume those responsibilities immediately. Thus, a node will automatically become a PNC if it is out of range of any other PNC.

Because PNC devices are elected immediately upon deployment, and without contention, every other node that is deployed after a PNC and in its transmission range immediately knows its role in the network (it will become a regular device 102). This eliminates all communications overhead, allowing fast deployment without initialization contention. Additionally, because piconets overlap, and many devices are deployed within the overlap region, the network is fully connected.

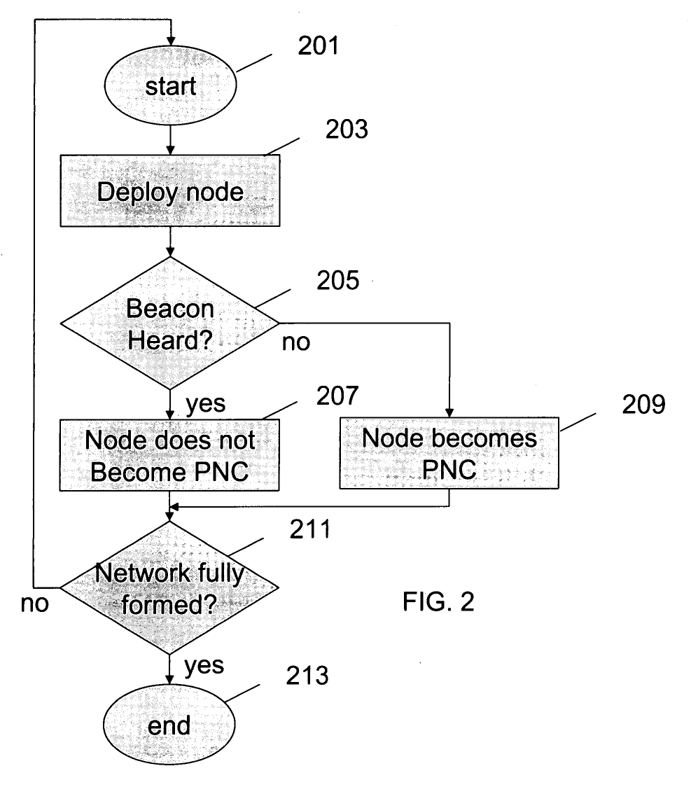

There are various ways to deploy each node, and are even more options as to how many to deploy and when to deploy them. In the preferred embodiment of the present invention nodes are periodically deployed serially from a backpack that is equipped to randomly (i.e., random in time) drop nodes as a firefighter (or any personnel) traverses the environment. As discussed, after deployment from the backpack, a node immediately determines its role (i.e., as that of a coordinator or not) and begins network communication. FIG. 2 is a flow chart showing these steps. In particular nodes automatically become a piconet coordinator if they are out of range of any other piconet coordinator.

The logic flow begins at step 201. At step 203 a node is deployed. As discussed above, once a node is deployed (e.g., dropped onto the ground), it immediately determines if a beacon is heard from any PNC 101 (step 205). If, at step 205 a beacon is heard, the logic flow continues to step 207 where the beacon assumes the role of a standard device 102, otherwise the logic flow continues to step 208 where the beacon assumes the role of PNC 101. At step 211 a determination is made to whether or not any more nodes need to be deployed, and if so the logic flow returns to step 201, otherwise the logic flow ends at step 213.

It should be noted that although the above procedure may be employed by hand, in the preferred embodiment of the present invention an individual is equipped with a node-distributing device that is capable of performing the aforementioned four-part process. Because of the short-range nature of communication between devices, any node distribution must be such that no node lies more than a predetermined distance from any other node. In order to accomplish this task, the node-distributing device can deploy based on the following criteria: walking speed, transmitted signal strength, node density measures, battery life of existing network nodes, channel congestion, or a combination of the former attributes with environmental parameters like temperature, moisture or humidity.

For example, a system that is deployed based on walking speed can calculate the distance between the most recently deployed node and the current position of the deployment mechanism by using velocity and time. When the calculated distance is greater than the maximal device separation threshold, another node will be deployed. If a new node is deployed and is not in range of a PNC, it will assume PNC responsibilities and start another piconet.

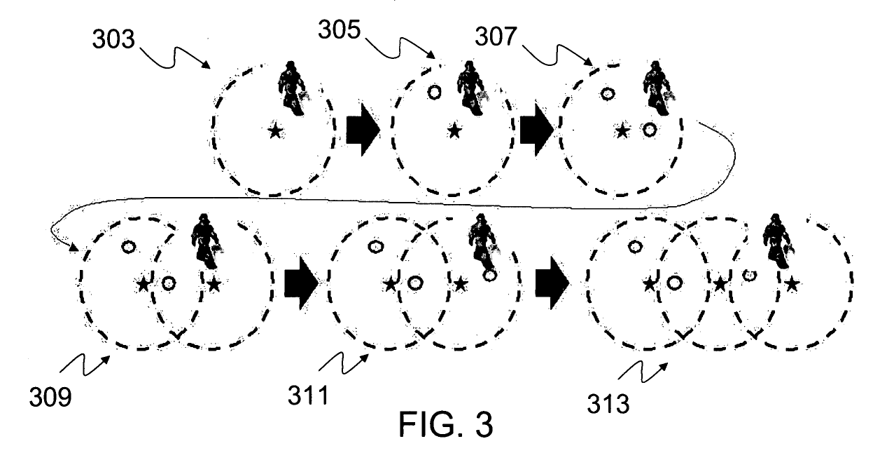

FIG. 3 illustrates node deployment. In particular, FIG. 3 shows a firefighter executing a progressive deployment algorithm to form a network of three piconets. FIG. 3 is displayed as a series of snapshots 301-313 in time as it progresses into a fully formed ad-hoc sensor network. Snapshot 301 shows one node deployed in an environment that is otherwise free of devices. Since there is no way for that node to hear a beacon from another PNC, it must assume the role of a PNC device (star). Snapshot 303 shows the same PNC with a second device that was just deployed. Since the second device is in range of a PNC, it assumes the role of a regular node (circle). Snapshot 305 shows another node being deployed. By snapshot 307, the firefighter is able to deploy a node that is outside the range of any PNC. When this node fails to detect a PNC beacon, it becomes a PNC. This process continues until the entire network has been deployed after snapshots 309, 311, and 313.

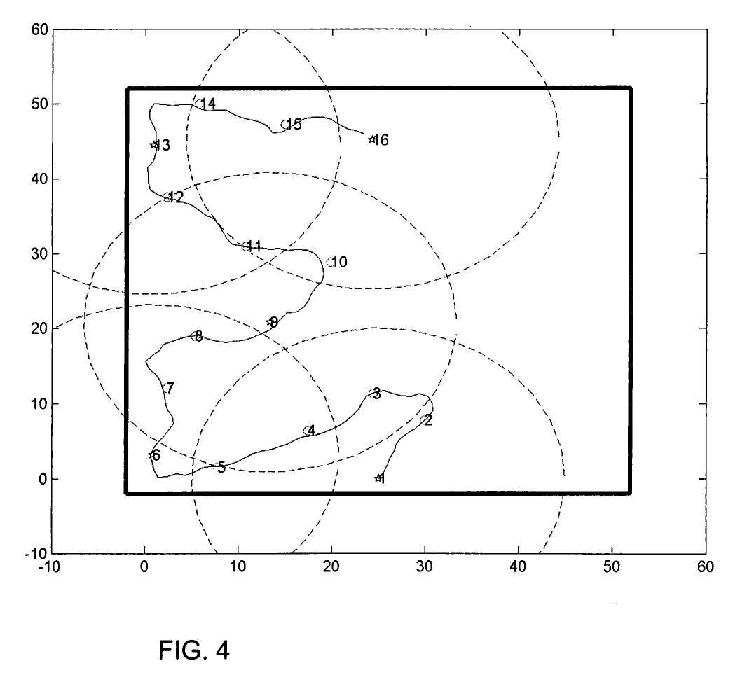

As discussed, there are a variety of characteristic that can be used to determine when a node is deployed. FIG. 4 shows a simulation for a random walk and random drop rate. In this example a fireman walks randomly and drops a node (whose transmit range is 15 meters radius) every 10 meters as he walks. A total of 16 nodes are dropped. The first node (node) becomes a PNC as discussed. The dotted circle in the figure represents the transmit range of each PNC. As the individual progresses, regular nodes are dropped at 2, 3, 4, and 5. PNC (node 1) is in range of all nodes dropped so far. Node 6 is then dropped, which becomes a PNC since it is out of the range of any PNC. This type of deployment ensures full connectivity.

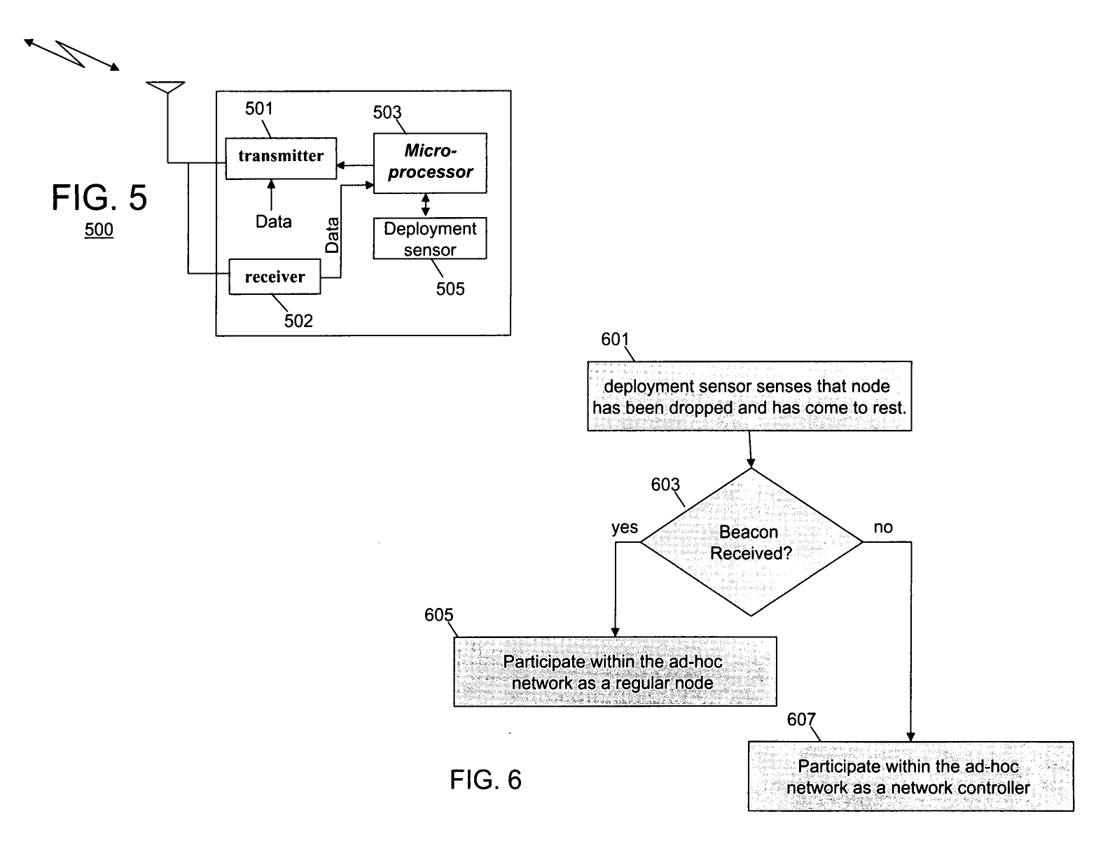

FIG. 5 is a high-level block diagram of node 500 in accordance with the preferred embodiment of the present invention. In the preferred embodiment of the present invention all nodes within ad-hoc communication system 100 contain the elements shown in node 500. As shown, node 500 comprises transmit circuitry 501, receive circuitry 502, and logic circuitry 503. Logic circuitry 503 preferably comprises a microprocessor controller, such as, but not limited to a Motorola PowerPC microprocessor. In the preferred embodiment of the present invention logic circuitry 503 serves as means for controlling node 500. Additionally receive and transmit circuitry 501 and 502 are common circuitry known in the art for communication utilizing a well known communication protocol. For example, for nodes within communication system 100, receiver 502 and transmitter 501 are well known neuRFon™ transmitters that utilize a modified neuRFon™ communication system protocol. Other possible transmitters and receivers include, but are not limited to transceivers utilizing Bluetooth, IEEE 802.11, or HyperLAN protocols. Finally, node 500 comprises deployment sensor 505. In a first embodiment of the present invention, deployment sensor 505 comprises an accelerometer that senses a sudden change in direction. In particular, accelerometer 505 senses when node 500 is dropped, and comes to rest.

FIG. 6 is a flow chart showing operation of node 500. The logic flow begins at step 601 where logic circuitry 503 determines if a node has been deployed by determining if deployment sensor 505 senses that node 500 has been dropped and has come to rest. The logic flow continues to step 603 where microprocessor 503 accesses receiver 502 and determines if receiver 502 senses a beacon. As discussed above, a beacon typically identifies a second node as a coordinator and provides system information to nodes in communication with the second node.

If a beacon is received by receiver 502, then the logic flow continues to step 605, otherwise the logic flow continues to step 607. At step 605 logic circuitry 503 instructs node 500 to perform standard ad-hoc communications, participating within the ad-hoc network as a regular node. Thus, node 500 will identify the node 500 as a coordinator by broadcasting a beacon that provides system information to nodes in communication with the node's range. At step 607 logic circuitry 503 instructs node 500 to perform standard ad-hoc communications, participating within the ad-hoc network as a network controller.

Although the above description was given with a node determining if it should become a piconet coordinator based on whether or not a beacon was detected, other techniques for becoming a piconet coordinator may be used. For example, once dropped, a node may determine whether or not to become a piconet coordinator based on the signal strengths of neighboring nodes. For example, if the signal strengths of all neighboring nodes are below a threshold, then there exists a good chance that the node may have trouble in communicating with already deployed piconet coordinators. The node may then become a piconet coordinator.

A node may additionally determine whether or not to become a piconet coordinator based on a perceived node density. For example, if a node determines that there exists a high density of nodes within a given area (e.g., 5) the node may decide to become a coordinator in order to reduce the service burden on the existing coordinators, even though at least one piconet coordinator is heard.

A node may additionally determine whether or not to become a piconet coordinator based on battery life of it or other nodes. For example, nodes serving as piconet coordinators utilize higher power consumption than regular nodes. Because of this, a node will not want to become a piconet coordinator if its battery reserve is low. In a similar manner, a node may wish to become a piconet coordinator if the existing coordinator has low battery reserves. Therefore, if a node is dropped and has little battery reserve, it will not become a piconet coordinator. In this situation, the next node dropped should become the piconet coordinator if its battery reserve permits. In a similar manner, if it is dropped and has good battery reserves, and the existing coordinator has poor reserves, it may choose to become a coordinator.

Finally, a node may additionally determine whether or not to become a piconet coordinator based on channel congestion. If, when dropped, neighboring nodes are indicating the existence of throughput delays based on the bottlenecks with existing coordinators, the next node that is dropped may elect to be a coordinator in order to reduce the traffic load on the existing piconet coordinators.

In summary, once deployed a node may utilize any one or any combination of several statistics/thresholds to determine whether or not to become a piconet coordinator. These thresholds include, but are not limited to:
becoming a coordinator if the node out of range of a piconet coordinator;
becoming a coordinator if the signal strengths of neighboring nodes are below a threshold,
becoming a coordinator if node density is above a threshold,
becoming a coordinator if battery life is above a threshold; and
becoming a coordinator if channel congestion is above a threshold.

While the invention has been particularly shown and described with reference to a particular embodiment, it will be understood by those skilled in the art that various changes in form and details may be made therein without departing from the spirit and scope of the invention. For example, while the above description was given with respect to a NeuRFon ad-hoc communication system, one of ordinary skill in the art will recognize that other communication system protocols may be utilized. For example, communication system 100 may utilize a Bluetooth, IEEE 802.11, or HyperLAN protocol. It is intended that such changes come within the scope of the following claims.

1. A method for deploying an ad-hoc network, the method comprising the steps of:
serially dropping a plurality of ad-hoc nodes throughout a geographic area; and
wherein the plurality of ad-hoc nodes automatically become a piconet coordinator based on a threshold.

2. The method of claim 1 wherein the step of becoming a piconet coordinator based on a threshold comprises the step of becoming a piconet coordinator when one of the following exists:
if the node out of range of a piconet coordinator;
if the signal strengths of neighboring nodes are below a threshold,
if node density is above a threshold, and
if battery life is above a threshold; and
if channel congestion is above a threshold.

3. The method of claim 1 wherein the step of periodically dropping the ad-hoc nodes comprises the step of randomly dropping the ad-hoc nodes.

4. The method of claim 1 wherein the ad-hoc nodes automatically become a piconet coordinator if the ad-hoc nodes fail to hear a beacon.

5. A method comprising the steps of:
determining that a node has been deployed;
determining if a beacon has been heard; and
becoming a piconet coordinator if the beacon has not been heard otherwise becoming a standard node within an ad-hoc communication system.

6. The method of claim 5 wherein the step of determining that the node has been deployed comprises the step of determining via an accelerometer if the node has been dropped.

7. The method of claim 5 wherein the step of determining if a beacon has been heard comprises the step of determining if a beacon is sensed that identifies a second node as a coordinator and provides system information to nodes in communication with the second node.

8. The method of claim 5 wherein the step of becoming the piconet coordinator comprises the step of identifying the node as a coordinator by broadcasting a beacon that provides system information to nodes in communication with the node's range.

9. The method of claim 8 wherein the system information comprises information taken from the group consisting of information for assigning unique network addresses to nodes, information for routing messages, information for broadcasting device discovery and service discovery information, and information necessary for power control.

10. An apparatus comprising:
a sensor determining that a node has been deployed; and
logic circuitry determining if a beacon has been heard and instructing the node to become a piconet coordinator if the beacon has not been heard, otherwise instructing the node to become a regular node within an ad-hoc communication system.

11. The apparatus of claim 10 wherein the sensor comprises an accelerometer.

12. The apparatus of claim 10 wherein the logic circuitry determines if a beacon has been heard by utilizing a receiver to determine if a beacon is sensed that identifies a second node as a coordinator and provides system information to nodes in communication with the second node.

13. The apparatus of claim 10 wherein the logic circuitry instructs the node to become the piconet coordinator by utilizing a transmitter to broadcast a beacon that provides system information to nodes in communication with the node's range.

14. The apparatus of claim 13 wherein the system information comprises information taken from the group consisting of information for assigning unique network addresses to nodes, information for routing messages, information for broadcasting device discovery and service discovery information, and information necessary for power control.

15. An apparatus comprising:
a sensor determining that a node has been dropped; and
logic circuitry determining whether or not to become a piconet coordinator based on if the node has been dropped, wherein the logic circuitry determines whether or not to become a piconet coordinator based on a statistic.

16. The apparatus of claim 15 wherein the statistic comprises at least one of the following:
if the node out of range of a piconet coordinator;
if the signal strengths of neighboring nodes are below a threshold,
if node density is above a threshold, and
if battery life is above a threshold; and
if channel congestion is above a threshold.
